(19) United States
(12) Patent Application Publication
(10) Pub. No.: US 2026/0318755 A1
(43) Pub. Date: Oct. 15, 2026

(54) Method and Device for Diagnosing a Battery System and Method and Device for Diagnosing a Vehicle Comprising the Battery System

(71) Applicant: Bayerische Motoren Werke Aktiengesellschaft, Muenchen (DE)

(72) Inventors: Martin HACKL, Muenchen (DE); Bernhard KREPPOLD, Fuerstenfeldbruck (DE); Joan MUNOZ GAYET, Muenchen (DE)

(21) Appl. No.: 19/100,262

(22) PCT Filed: Jul. 19, 2023
(86) PCT No.: PCT/EP2023/070006

§ 371 Date: Jan. 31, 2025

(30) Foreign Application Priority Data
Aug. 3, 2022 (DE) 10 2022 119 467.1

(51) Int. Cl. G01K 15/00; B60L 58/10; G01K 7/22; H01M 10/42; H01M 10/48

(52) U.S. Cl. CPC G01K 15/007; B60L 58/10; G01K 7/22; H01M 10/4285; H01M 10/486; H01M 2220/20

(57) ABSTRACT

A vehicle has a battery system comprising at least one device element and at least one temperature sensor. The temperature sensor, when used for its intended purpose, is thermally coupled to the respective device element in a predetermined manner and its measurement signal is representative of a temperature of the temperature sensor in a measurement mode. In a heating mode, the temperature sensor is operated such that it generates an increased thermal power loss compared to the measurement mode. A characteristic value for a thermal influence of the heating mode on the temperature sensor is determined depending on the measurement signal of the temperature sensor in the measurement mode. Depending on a predetermined characteristic and the characteristic value, it is determined whether the temperature sensor is thermally coupled in a predetermined manner to the respective device element.

### BACKGROUND AND SUMMARY

The invention relates to a method and to a corresponding device for diagnosing a battery system, and further relates to a method and to a corresponding device for diagnosing a vehicle comprising the battery system.

Battery systems are assuming increasing economic significance, particularly in the context of e-mobility in vehicles. In the interests of reliability, it is important, in this context, that faults on one or more battery cells of the battery system are detected. To this end, it is known for one or more temperature sensors to be employed, by the measurement signal of which the respective temperature of a respective battery cell can be inferred. This measurement signal is then employed for the promptest possible detection of an overtemperature on the respective battery cell, and/or for the protection of the latter against degradation associated with an increased charging or discharge current of the battery cell. In this manner, it is intended to ensure the longest possible service life of the battery cell, and to prevent the occurrence of any “thermal events” which, in extreme cases, can result in a destruction of the respective battery cell.

One object to be fulfilled is the provision of a method for diagnosing a battery system or of a method and a corresponding device for diagnosing a vehicle having the battery system, which deliver(s) a contribution to a reliable operation of the battery system.

This object is fulfilled by the subject matter disclosed herein. Advantageous configurations of the invention are also disclosed herein.

According to a first aspect, the invention is characterized by a method for diagnosing a battery system having at least one device element and having at least one temperature sensor which, when employed in a regulation manner, is thermally coupled to the respective device element, and the measurement signal of which, in a measurement mode, is representative of a temperature of the temperature sensor. As a respective device element, arbitrary elements can be considered such as, for example, a battery cell, a cooling element or similar.

According to the first aspect, the temperature sensor is operated in a heating mode such that, in comparison with the measurement mode, it generates an increased thermal power loss. The heating mode is thus characterized, for example, in that the temperature sensor is deliberately operated such that it assumes a high thermal power, in comparison with a measurement mode, in which it is operated with the lowest possible thermal power loss. In the measurement mode, the temperature sensor is preferably operated such that its power loss is low, such that a temperature of the temperature sensor is substantially unaffected, thereby contributing to a high quality of measurement. In the heating mode, for example, the temperature sensor is operated such that, in comparison with the measurement mode, the thermal power loss generated is exemplarily at least 25%, further exemplarily at least 50%, further exemplarily at least 100%, and further exemplarily at least 300% greater than in the case of a comparable measurement mode, particularly in relation to a starting temperature of the temperature sensor prior to the commencement of the heating mode.

According to a first aspect, a characteristic variable for a thermal influence of the heating mode upon the temperature sensor is ascertained, depending upon the measurement signal of the temperature sensor in the measurement mode. It is further ascertained, according to a predetermined characteristic and the characteristic variable, whether the temperature sensor is thermally coupled to the respective device element in a regulation manner.

Thus, for example, in the heating mode, with a power loss increased by approximately 300% on the temperature sensor, in the event that the latter is not thermally coupled to the respective device element in a regulation manner, a heat-up by 0.3 K is obtained. It has been established that this is sufficient for a robust diagnostic discrimination.

In particular, the characteristic variable can be the following: one or more characteristic values, a characteristic of multiple characteristic values, or an arbitrary function which is dependent upon one or more characteristic values.

The predetermined characteristic, in particular, is selected in accordance with a specific configuration of the characteristic variable, and is thus predetermined such that, in accordance with the predetermined characteristic and the current characteristic variable, it can be concluded whether the temperature sensor is thermally coupled to the respective device element in a regulation manner. In a particularly simple configuration, for example, the predetermined characteristic can be a predetermined threshold value. However, in the same manner as the characteristic variable, it can also be, for example, a predetermined characteristic or an arbitrary function.

By the procedure according to the first aspect, an efficient contribution is delivered to the reliable detection of an insufficient or absent thermal connection of the temperature sensor to the respective device element, particularly with respect to the thermal coupling thereof, thus enabling the prompt implementation of corresponding measures for the protection of the battery system.

By the first aspect, for example as early as a production operation of the battery system, it can thus be detected if the temperature sensor is not thermally coupled to the respective device element in the manner required and, for example, corresponding quality assurance measures can be implemented. Even after the initial commissioning of the battery system, a contribution can thus be delivered to the prompt detection of a fault of this type, thus delivering a contribution to the greatest possible service life and efficiency of the battery system.

According to a second aspect of the invention, the latter is characterized by a device for executing the method according to the first aspect, and corresponds thereto accordingly.

According to a third aspect, the invention is characterized by a method for diagnosing a vehicle having the battery system, wherein the method is executed according to the first aspect.

According to a fourth aspect, the invention is characterized by a device for diagnosing a vehicle, which is configured to execute the method according to the third aspect.

Advantageous configurations are disclosed herein.

According to one advantageous configuration, the characteristic variable is ascertained according to a measurement mode of the temperature sensor, further to a termination of the heating mode. By this arrangement, diagnosis can be executed in a particularly simple manner.

According to a further advantageous configuration, the characteristic variable is ascertained according to a measurement mode of the temperature sensor, prior to a commencement of the heating mode. In this manner, a significant contribution can be delivered to the appropriate consideration of a marginal condition or conditions, promptly in advance of the commencement of the heating mode. In this context, in particular, the finding is exploited to the effect that a starting temperature of the temperature sensor exerts a critical influence upon the temperature thereof further to the heating mode. In this manner, by a corresponding consideration, a quality of diagnosis can be enhanced.

According to a further advantageous configuration, the characteristic variable is ascertained according to a measurement mode of the temperature sensor during at least one short-term interruption of the heating mode. In this manner, in particular, a contribution to a very rapid diagnosis is delivered.

According to a further advantageous configuration, a duration of the heating mode is ascertained according to a characteristic value of the temperature of the temperature sensor prior to the commencement of the heating mode. In this manner, in particular, a contribution can be delivered to an appropriate consideration of the characteristics of the temperature sensor, with respect to a desired thermal power loss of the temperature sensor during a heating mode. This is particularly effective in conjunction with a temperature sensor, the electrical resistance of which is dependent upon temperature.

According to a further advantageous configuration, one input of an evaluation unit, for tapping the measurement signal in the heating mode, is switched to a predetermined voltage potential, which initiates an increased current flux in the temperature sensor, in comparison with the measurement mode. In this manner, the heating mode can be executed in a very simple manner, optionally without the necessity for the execution of any hardware modifications to an existing evaluation unit. In this context, it can be particularly advantageous that the input is switched to a ground potential during the heating mode.

According to an advantageous configuration of the third or fourth aspects, the method according to the third aspect is executed during a predetermined stationary operation of the vehicle. By this arrangement, it can be ensured, in a simple manner, that any corrupting influences upon a diagnosis, which might occur outside the stationary operation of the vehicle, are excluded.

Exemplary embodiments of the invention are described in greater detail hereinafter, with reference to the schematic diagrams.

### BRIEF DESCRIPTION OF THE DRAWINGS

FIG. 1 shows a vehicle having a battery system;

FIG. 2 shows the battery cell system;

FIG. 3 shows a section of a battery cell with a temperature sensor, in a first condition;

FIG. 4 shows a section of a battery cell with the temperature sensor, in a second condition;

FIG. 5 shows an evaluation unit having a circuit arrangement, in which the sensor is incorporated;

FIG. 6 shows a flow diagram;

FIG. 7 shows first signal characteristics;

FIG. 8 shows second signal characteristics;

FIG. 9 shows third signal characteristics.

### DETAILED DESCRIPTION OF THE DRAWINGS

In all the figures, elements having an identical construction or function are identified by the same reference symbols.

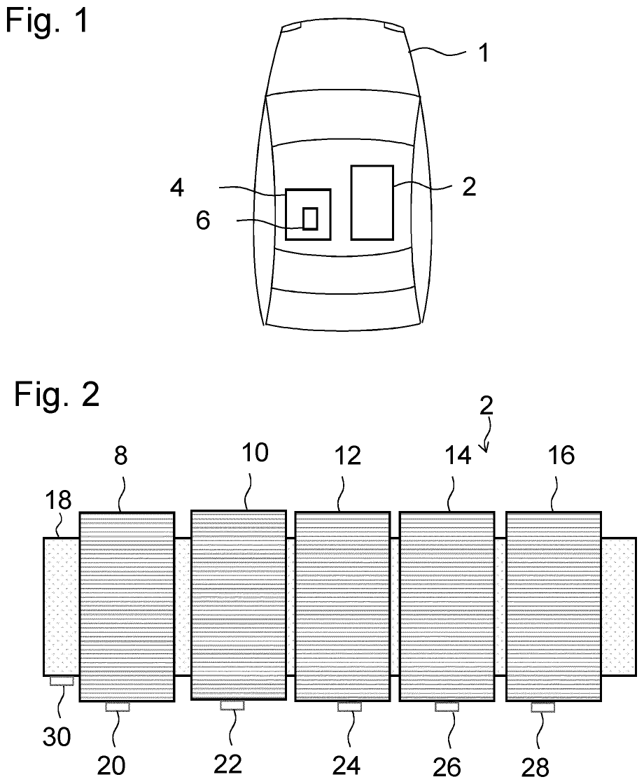

FIG. 1 shows a vehicle 1 having a battery system 2. The battery system 2 is designed for the storage and release of electrical energy, which can be employed, for example, for powering an electric drive of the vehicle.

Moreover, a control device 4 is arranged in the vehicle 1, which is configured for diagnosing the battery system 2. Additionally, the control device 4 can also assume further functions within the vehicle, or with respect to the battery system 2. Moreover, an evaluation unit 6 is configured, in particular in the control device 4.

The battery system 2 (FIG. 2) comprises a plurality of battery cells 8 to 16. Although the battery cells 8 to 16, for example, can be lithium-ion battery cells, they can also be other arbitrary types of battery cells 8 to 16, for example solid body battery cells. In principle, the cell format of the battery cells 8 to 16 can also be arbitrarily selected. For example, the cells can also be “pouch cells”.

The battery system 2 further comprises a cooling element 18, which is thermally coupled to one or more of the battery cells 8 to 16, and is configured for evacuating heat from the battery cells 8 to 16.

Moreover, one or more temperature sensors 20, 22, 24, 26, 28, 30 are provided which, in a regulation manner, are thermally coupled to a respective device element, and the respective measurement signal of which, in a measurement mode, is representative of a temperature of the respective temperature sensor 20 to 30.

In the present example, the device element can be, for example, a respective battery cell 8 to 16, or can also be, for example, the heat sink 18.

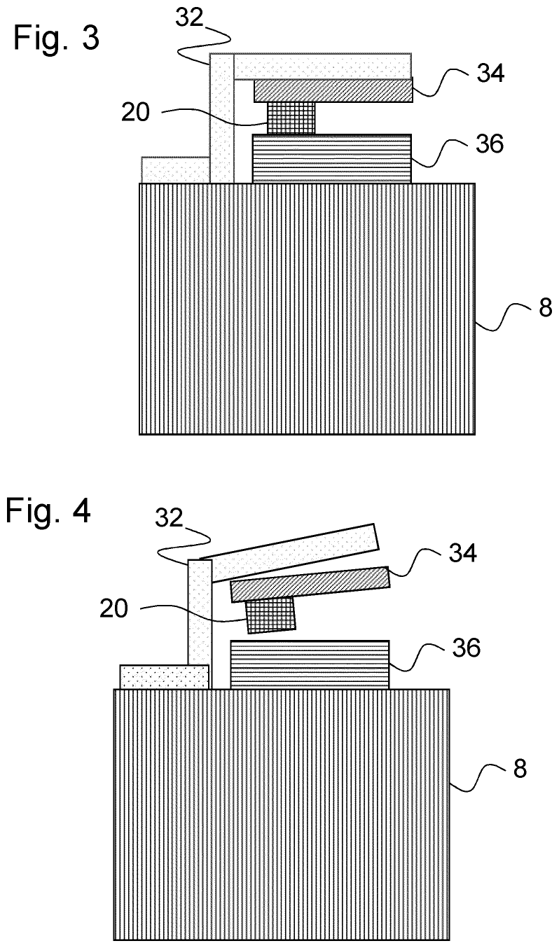

With reference to FIG. 3, an arrangement of the temperature sensor 20 in relation to the battery cell 8 is represented in detailed form. A hold-down device 32 is provided which, in its intended operation, cooperates with a connecting element 34 and a thermal coupling element 36, by way of contribution to a predetermined thermal coupling with a battery cell 8.

The hold-down device 32, in the sectional representation according to the figure, is shown in a dotted representation.

The connecting element 34, in particular, is configured for an electrical connection of the temperature sensor 20, and thus comprises, in particular, corresponding conductor structures. It can be configured, for example, in the form of a “flexible printed conductor” or FPC.

If the temperature sensor 20 is thermally coupled, in a regulation manner, to another device element of the battery system 2, the latter can be configured in a corresponding arrangement, as exemplarily represented here with respect to the battery cell 8.

FIG. 4 shows the arrangement according to FIG. 3 in the event of a fault, in which the temperature sensor 20 is not thermally coupled, in a regulation manner, to the respective device element, in the present example to the battery cell 8. As can be seen from FIG. 4, in the present case, the temperature sensor 20 is detached from the thermal coupling element 36, and a gap is thus at least present between the temperature sensor 20 and the thermal coupling element 36, which gap, for example, is air-filled. This results in a substantially increased thermal resistance between the temperature sensor 20 and the thermal coupling element 36, and thus the battery cell 8. A temperature of the temperature sensor 20, in the measurement mode, thus correlates only inadequately, if at all, to that of the battery cell 8.

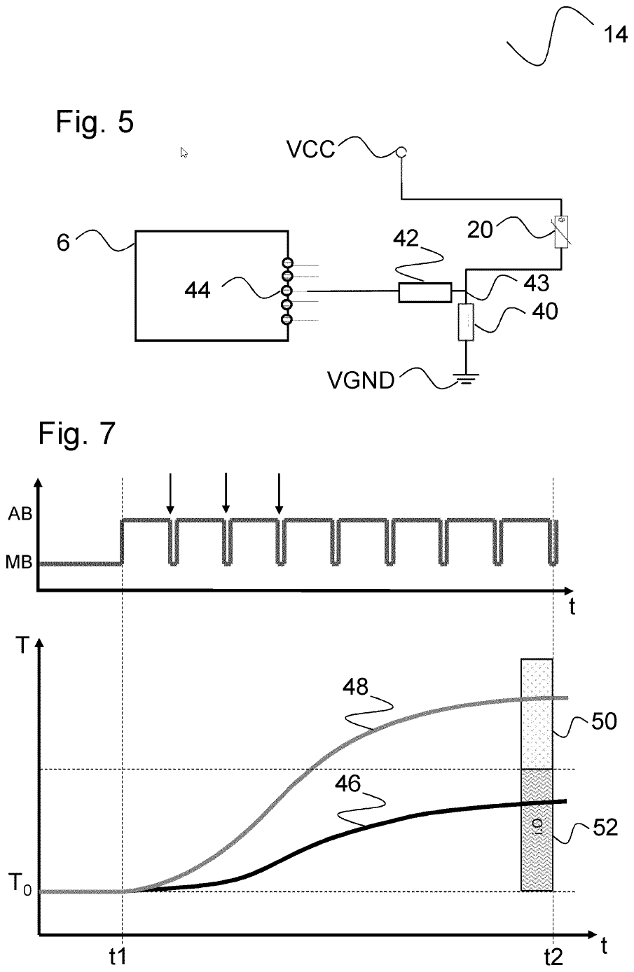

FIG. 5 shows a circuit arrangement incorporating the temperature sensor 20, wherein the latter can also be employed in an analogous manner to the temperature sensors 22 to 30 and 38.

The temperature sensor 20 is connected in series with a voltage divider resistor 40. VCC describes a supply voltage potential, and VGND describes a reference potential. The voltage divider resistor 40, for example, is dimensioned such the resistance thereof approximately corresponds to that of the temperature sensor 20, at a predetermined reference temperature such as, for example, 25 °C. This resistance, for example, can be 10 kΩ. In this case, the temperature sensor preferably assumes an electrical resistance of approximately 10 kΩ at the reference temperature. For example, the temperature sensor can be configured as a NTC resistor, and thus assumes a negative temperature coefficient. Optionally, moreover, a low-pass resistor 42 can be provided in a voltage tap 43, which can be an element of a low-pass arrangement which is not represented in greater detail here, and which thus also comprises a capacitance. The voltage tap 43 is electrically coupled to an input/output 44 of the evaluation unit 6, which can also be described as a port. If the input/output 44 is operated as an input, it can be configured, for example, to deliver the measurement signal which, in particular, represents the voltage on the voltage tap, to an analog-digital converter in the evaluation unit 6. In another state, the input/output 44 can be configured in the evaluation unit 6 such that the voltage divider resistor 40 is bridged. This means that the reference potential VGND is essentially applied to the input/output 44. To this end, for example, operation can be executed in an “open-drain” arrangement. The optional low-pass resistor 42 is dimensioned such that, even in the presence thereof, the voltage drop between supply voltage potential VCC and the reference potential VGND, in this case, essentially occurs across the temperature sensor 20.

In a heating mode AB, the temperature sensor 20 is operated such that, in comparison with a measurement mode MB, it generates an increased thermal power loss. In the circuit arrangement represented in FIG. 5, the measurement mode MB is executed such that input/output 44 is coupled to the analog-digital converter, and thus assumes a high resistance, such that the supply voltage VCC, in relation to the reference potential VGND on the temperature sensor 20, decays in accordance with the ratio of the resistances of the temperature sensor 20 and the voltage divider resistor.

In the heating mode AB, the reference potential VGND is essentially applied to the input/output 44, as a result of which essentially the entire voltage between the supply voltage potential VCC and the reference potential VGND falls across the temperature sensor 20. As a result, in this case, the power loss, in the event that the temperature corresponds to the reference temperature, is approximately four times that associated with the measurement mode.

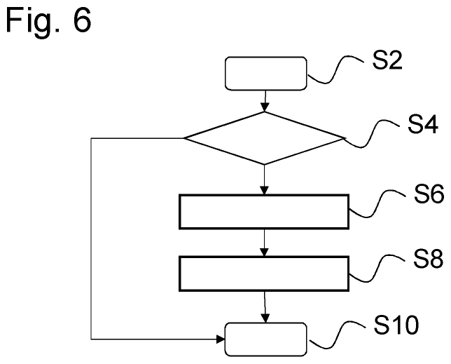

FIG. 6 represents a flow diagram of a program which, in particular, can be saved in the evaluation unit 6 and executed therein during operation. Alternatively, the program, or elements thereof, can also be saved and/or executed in another unit of the control device 4.

The program can be started in step S2 at an arbitrary time point. Thus, for example, the program can be started at the conclusion of a production of the battery system 2, in the context of an “end-of-line test”. In principle, however, it can also be started at arbitrary subsequent time points.

In a step S4, a check is executed with respect to the assumption by the vehicle 1 of a predetermined stationary operation. Stationary operation can be detected, for example, wherein a high-voltage supply of the battery system 2 is deactivated and/or contactors of the battery system 2 are switched off. Overall, stationary operation is characterized in that the vehicle 1 is not actively in service. By this arrangement, it can be confirmed, in a simple manner, that influences, for example associated with an active heat-up of the battery cells 8 to 16 during the execution of the diagnosis, result in unwanted temperature variations, or that a potentially occurring acceleration process of the vehicle is associated with a high power drain in the battery cells 8 to 16, which can result in a significant increase in the cell temperature of the respective battery cells 8 to 16 within a very short time frame, for example within seconds.

If it is established in step 4 that the vehicle 1 is in stationary operation, processing continues in step 6. Otherwise, processing terminates at a step 10.

In step S6, the temperature sensor is operated in the heating mode AB for a predetermined heating time. Preferably, in very close temporal proximity to the commencement of the heating mode, the temperature sensor 20 to 30 is operated in the measurement mode MB, and thus ascertains a characteristic value for a starting temperature of the temperature sensor 20 to 30. For example, the heating time can then be additionally ascertained, in accordance with the characteristic value for the starting temperature.

In a step S8, which is executed successively in time to step S6 or, alternatively, can optionally be executed multiple times, intermittently with step S6, a characteristic variable is ascertained for a thermal influence of the heating mode upon the temperature sensor 20 to 30, according to the measurement signal of the temperature sensor 20 to 30 in the measurement mode MB. Detailed examples of this procedure are described in detail hereinafter, with reference to the further figures.

Moreover, in step S8, according to a predetermined characteristic and the characteristic variable, it is ascertained whether the temperature sensor 20 is thermally coupled to the respective device element in the stipulated manner. The respective device element can be, for example, the respective battery cell 8 to 16 or, for example, can also be the heat sink 18.

Although the predetermined characteristic can be stipulated, in a particularly simple manner, in the form of a threshold value, it can also be stipulated in the form of a predetermined characteristic or an arbitrary function, particularly according to the selection of the respective characteristic variable. The predetermined characteristic is preferably ascertained beforehand by corresponding tests, respectively employing an arrangement in which the temperature sensor 20 to 30 is thermally coupled, in a regulation manner, to the respective device element, or is not thermally coupled, in a regulation manner, to the respective device element. On the basis hereof, a corresponding diagnosis or diagnostic statement can be executed in step S8 with respect to a regulation or non-regulation thermal coupling of the respective temperature sensor. It can thus be detected, in a very prompt manner, that the temperature sensor 20, at the time of assembly, is already lacking an adequate thermal connection, or has lost the latter in the course of operation, as a result of mechanical detachment. In this manner, it can thus be rapidly detected that, from the measurement signal of the temperature sensor, in the event of the respective fault, an overtemperature of the respective battery cell 8 to 6 can no longer be inferred, and corresponding measures can be implemented. Measures can thus be implemented, in the event of a fault, in order to prevent any degradation of the battery cell associated with an excessively high charging and/or discharge current of the battery cell. An exceptionally long service life can thus be ensured, and a “thermal event” can be prevented.

In the absence of the procedure described in the above-mentioned steps, a detection of this fault pattern is only possible in the event of a very rapid temperature variation of the respective battery cell 8 to 16 or of the heat sink, associated with the current flux or coolant flux. In such cases, however, a potentially technically-related temperature spread also occurs within the battery system 2, such that a poorly connected temperature sensor 20 to 30 can only be detected with difficulty. Moreover, diagnoses based upon such effects are of limited suitability for “end-of-line testing” in the battery system 2. Under certain circumstances, corresponding fault cases might have consequences which only become evident in service, resulting in unscheduled workshop visits or complete recall programs.

In a following step S10, the program is then terminated and, further to a predetermined time interval or upon the occurrence of a predetermined event, can then be restarted at step S2.

FIG. 7 shows two signal diagrams, which are plotted against time t, wherein it is represented, in the upper diagram, whether the temperature sensor is operating in the measurement mode MB or in the heating mode AB. The time axes and time references are identical in both of the diagrams in FIG. 7. T describes the temperature. Commencing from a starting temperature T0, the heating mode is started at a time point t1 and, in principle, is executed up to a time point t2. In the present example, intermittently, a short-term switchover to the measurement mode MB is executed, as highlighted by arrows in the upper signal characteristic. The characteristic variable for the thermal influence of the heating mode upon the temperature sensor can thus be ascertained during the heating mode AB, i.e., for example, the temperature characteristic of the temperature sensor can be estimated by interpolation. In this manner, it can be very rapidly detected whether the temperature of the temperature sensor 20 to 30 assumes a temperature characteristic according to reference symbol 46, or otherwise according to reference symbol 48. The temperature characteristic 46 represents that characteristic which is associated with a regulation thermal coupling of the temperature sensor 20 to the respective device element, whereas temperature characteristic 48 represents a non-regulation thermal coupling of the temperature sensor 20 to the respective coupling element. The characteristic variable for the thermal influence of the heating mode can then be ascertained, for example, in accordance with the approximated temperature characteristic. In a particularly simple configuration, simply at time point t2, the respective measurement signal can be considered as critical to the ascertainment of the characteristic variable, and the stipulated characteristic can then be a corresponding threshold value. This can be selected such that a distinction can be drawn between a first temperature range 50 and a second temperature range 52 wherein, in the second temperature range 52, it is concluded that the temperature sensor 20 to 30 is thermally coupled to the respective device element in a regulation manner whereas, in the first temperature range 50, it is concluded that the respective temperature sensor 20 to 30 is not thermally coupled to the respective device element in a regulation manner.

By reference to the temperature characteristics 46 and 48, it can be seen that actuation of the heating mode initiates a step-function response. In the context of diagnosis, moreover, knowledge is employed to the effect that the respective temperature sensor 20, inclusive of its mechanical fastening and all elements which are involved herein by which a thermal coupling is possible, assumes a thermal capacity which is smaller, by several orders of magnitude, than that of the respective device element which, for example, can be the battery cell 8 to 16, or which can also be, for example, the heat sink 18. The increased power loss associated with the heating mode AB, in the event of regulation thermal coupling to the device element, can be diverted with a very low thermal resistance into the respective device element. In this case, only a relatively small temperature increase of the temperature sensor 20 to 30 is introduced, vis-à-vis the starting temperature T0.

In the event of a poor or non-existent thermal connection of the respective temperature sensor 20 to 30 to the respective device element, the resulting power loss can only be evacuated via the ambient air and, optionally, by a feeder line, each of which has a comparatively high thermal resistance. As a result, a substantially greater temperature increase of the temperature sensor 20 to 30 is introduced, vis-à-vis the starting temperature. The temperature characteristic of the temperature sensor 20 to 30 further to the commencement of self-excitation, i.e. further to the start of actuation of the heating mode AB, as a result of the comparatively increased energization, is characteristic of a quality of the thermal coupling of the temperature sensor 20 to 30 to the respective device element.

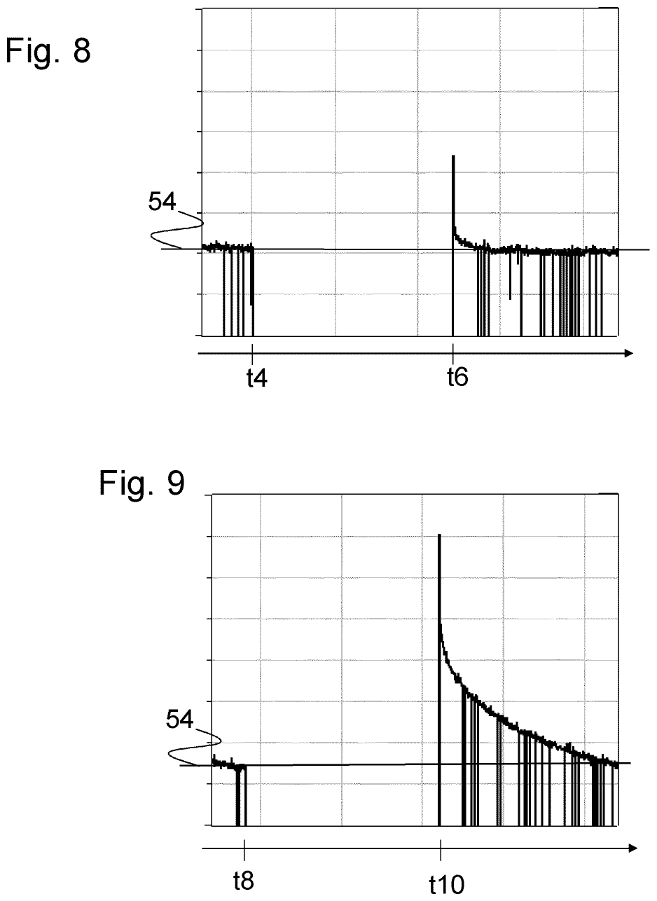

By reference to FIGS. 8 and 9, a further example of the execution of diagnosis is represented, which can be combined with the procedure according to FIG. 7.

At a time point t4, further to the measurement mode MB, the heating mode AB is initiated, and terminates at a time point t6. The characteristics plotted in FIGS. 8 and 9 represent the respective measurement signal of the temperature sensor 20 to 30 in the measurement mode.

According to FIG. 9, correspondingly to FIG. 8, further to the measurement mode in a step t8, the heating mode is initiated, and terminates at a time point t10. Under equivalent starting conditions, i.e. in particular at an identical starting temperature, the time intervals between time points t6 and t4 and between t10 and t8, in particular, are identical. The measurement signal characteristic according to FIG. 8 represents that characteristic which is associated with a regulation thermal coupling of the temperature sensor 20 to 30 to the respective device element, whereas that according to FIG. 9 represents that characteristic which is associated with a non-regulation thermal coupling of the temperature sensor 20 to 30 to the respective coupling element. 54 thus represents a reference curve which, for example, is ascertained in accordance with the starting temperature prior to the commencement of the heating mode AB.

It can clearly be seen that the measurement signal in FIG. 8 converges with the reference curve 54 far more rapidly, in comparison with FIG. 9. This can thus be considered in the ascertainment of the characteristic variable, and also of the stipulated characteristic. Thus, for example, further to a predeterminable time interval following the termination of the measurement mode MB, the measurement signal can be tapped one or more times in the course of the measurement mode MB and the characteristic variable ascertained therefrom, and then compared, for example, with a threshold value. In a more complex configuration, for example, an integral between the measurement signal and the reference curve 54 can also be ascertained, and the characteristic variable ascertained accordingly. It has been established, for example, that even after approximately two minutes of the heating mode AB, in the event of a non-regulation thermally coupled temperature sensor 20 to 30, an approximately three-fold higher temperature increase vis-à-vis the starting temperature T0 is introduced, in comparison with a device element which is thermally coupled in a regulation manner.

### REFERENCE SYMBOLS

1 Vehicle
2 Battery system
4 Control device
6 Evaluation unit
8-16 Battery cell
18 Heat sink
20-30 Temperature sensor
32 Hold-down device
34 Connecting element
36 Thermal coupling element
VCC Supply voltage potential
VGND Reference potential
40 Voltage divider resistor
42 Low-pass resistor
43 Voltage tap
44 Input/output
t Time
T Temperature
T0 Starting temperature
AB Heating mode
MB Measurement mode
46 Temperature characteristic
48 Temperature characteristic
50 First temperature range
52 Second temperature range
54 Reference curve
S2-S10 Steps

1-9. (canceled)

10. A method for diagnosing a battery system having at least one device element and having at least one temperature sensor which, when employed in a regulation manner, is thermally coupled to the respective device element, and a measurement signal of which, in a measurement mode, is representative of a temperature of the temperature sensor, the method comprising:
operating the temperature sensor in a heating mode such that, in comparison with the measurement mode, the temperature sensor generates an increased thermal power loss;
ascertaining a characteristic variable for a thermal influence of the heating mode upon the temperature sensor, depending upon the measurement signal of the temperature sensor in the measurement mode; and
ascertaining, according to a predetermined characteristic and the characteristic variable, whether the temperature sensor is thermally coupled to the respective device element in a regulation manner.

11. The method according to claim 10, comprising:
ascertaining the characteristic variable according to the measurement mode of the temperature sensor further to a termination of the heating mode.

12. The method according to claim 10, comprising:
ascertaining the characteristic variable according to the measurement mode of the temperature sensor prior to a commencement of the heating mode.

13. The method according to claim 10, comprising:
ascertaining the characteristic variable according to the measurement mode of the temperature sensor during at least one short-term interruption of the heating mode.

14. The method according to claim 10, comprising:
ascertaining a duration of the heating mode according to a characteristic value of the temperature of the temperature sensor prior to commencement of the heating mode.

15. The method according to claim 10, comprising:
switching an input/output of an evaluation unit, for tapping the measurement signal in the heating mode, to a predetermined voltage potential, which initiates an increased current flux in the temperature sensor in comparison with the measurement mode.

16. The method according to claim 10,
wherein the battery system is installed in a vehicle, and
wherein the method is executed during a predetermined stationary operation of the vehicle.

17. A device for diagnosing a battery system, wherein the battery system comprises at least one device element and at least one temperature sensor which, when employed in a regulation manner, is thermally coupled to the respective device element, and a measurement signal of which, in a measurement mode, is representative of a temperature of the temperature sensor,
wherein the device operatively coupled to the at least one temperature sensor, and wherein the device is configured to:
operate the at least one temperature sensor in a heating mode such that, in comparison with the measurement mode, the at least one temperature sensor generates an increased thermal power loss;
ascertain a characteristic variable for a thermal influence of the heating mode upon the at least one temperature sensor, depending upon the measurement signal of the at least one temperature sensor in the measurement mode; and
ascertain, according to a predetermined characteristic and the characteristic variable, whether the at least one temperature sensor is thermally coupled to the respective device element in a regulation manner.

18. The device according to claim 17, wherein the device is configured to:
ascertain the characteristic variable according to the measurement mode of the temperature sensor further to a termination of the heating mode.

19. The device according to claim 17, wherein the device is configured to:
ascertain the characteristic variable according to the measurement mode of the temperature sensor prior to a commencement of the heating mode.

20. The device according to claim 17, wherein the device is configured to:
ascertain the characteristic variable according to the measurement mode of the temperature sensor during at least one short-term interruption of the heating mode.

21. The device according to claim 17, wherein the device is configured to:
ascertain a duration of the heating mode according to a characteristic value of the temperature of the temperature sensor prior to commencement of the heating mode.

22. The device according to claim 17, wherein the device is configured to:
switch an input/output configured to tap the measurement signal in the heating mode, to a predetermined voltage potential, which initiates an increased current flux in the temperature sensor in comparison with the measurement mode.

23. A vehicle comprising:
the device according to claim 17; and
the battery system,
wherein the device is configured to perform the operations during a predetermined stationary operation of the vehicle.
